(19) United States
(12) Patent Application Publication
(10) Pub. No.: US 2006/0151270 A1
(43) Pub. Date: Jul. 13, 2006

(54) Hydraulic damping system for vehicle

(76) Inventors: Kouji Sakai, Shizuoka-ken (JP); Seiji Sawai, Shizuoka-ken (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/301,616

(22) Filed: Dec. 13, 2005

Related U.S. Application Data
(63) Continuation of application No. PCT/JP04/08332, filed on Jun. 14, 2004.

(30) Foreign Application Priority Data
Jun. 13, 2003 (JP) 2003-169420

(51) Int. Cl. F16F 9/00

(52) U.S. Cl. 188/313

(57) ABSTRACT

A pair of damping hydraulic cylinders can be provided on a vehicle body. A first oil chamber and a second oil chamber are in communication with upper oil chambers of the hydraulic cylinders. A bypass passage for allowing communication between the oil chambers is provided separately from both a first communication passage and a second communication passage of a second piston having a throttle. An opening-closing valve and a throttle are provided in the bypass passage

### RELATED APPLICATIONS

This application is a Continuation of PCT Application No. PCT/JP2004/8332, filed Jun. 14, 2004, which claims priority to Japanese Application No. 2003-169420, filed Jun. 13, 2003, the entire contents of both of which are hereby incorporated by reference.

### BACKGROUND OF THE INVENTIONS

1. Field of the Inventions

The present inventions relate to a hydraulic damping systems, and more particularly, hydraulic damping systems with variable damping force in which a damping force can be increased.

2. Description of the Related Art

A conventional hydraulic variable damping system for an automobile is disclosed for example in Japanese Patent Document No. JP-A-H8-132846. This hydraulic damping system has an intermediate unit connected to first and second hydraulic cylinders which support a vehicle body.

The intermediate unit includes a first pressure regulating cylinder having a first oil chamber in communication with an oil chamber of the first hydraulic cylinder, a second pressure regulating cylinder having a second oil chamber in communication with an oil chamber of the second hydraulic cylinder and in communication through a variable throttle with the first oil chamber. A free piston in both of the pressure regulating cylinders forms part of the walls of the first and second oil chambers. A high pressure gas chamber is formed on the opposite side of the first and second oil chambers across the free piston, and others. The free piston is configured such that changes in volume of the first and second oil chambers due to the free piston movement remain at a constant ratio.

With such a hydraulic damping system, when the first and second hydraulic cylinders move in the same direction and the magnitudes of their respective movements are about the same, the free piston moves and the volumes of the first and second oil chambers increase or decrease such that their changes are maintained in a constant ratio. In this case, working oil does not flow through the variable throttle. On the other hand, when the movements of the first and second hydraulic cylinders are opposite to each other, the free piston is generally stationary and the working oil flows through the variable throttle. Therefore, in this case, the damping force relatively increases.

The variable throttle is made up of check valves, each having a valve member constituted of a disk-shaped plate spring and a spool valve interposed between the first oil chamber and the second oil chamber in parallel with the check valve. Two types of check valve are used; one permitting oil flow from the first oil chamber to the second oil chamber, and the other permitting oil flow from the second oil chamber to the first oil chamber.

During operation of the spool valve, a spool is pushed from one side with a solenoid against the resilient force of a first compression coil spring. Another compression coil spring is disposed at the other end of the spool. The working oil passage is opened and closed by switching between excited state and de-excited state of the solenoid to move the spool along its axial direction.

With this spool valve, it is possible, by changing the amount of electric current supplied to the solenoid, to move the spool to a position where the resultant force of the force by the solenoid and the resilient force of the first compression spring, and the resilient force of the second compression spring are in balance, to regulate the cross-sectional area of the working oil flow passage. In other words, when energized, the spool moves to a position where the thrust of the solenoid and the reaction force of the balancing spring are in balance. This can provide generally proportional control of the valve openings.

With such a conventional hydraulic damping system, because resistance to the flow of working oil is increased and decreased by changing the cross-sectional area of the variable throttle using the spool valve by changing the amount of electric current supplied to the solenoid, it is possible to change the magnitude of the damping force produced by stroke speed difference between the first and second hydraulic cylinders.

### SUMMARY OF THE INVENTIONS

An aspect of at least one of the embodiments disclosed herein includes the realization that spool valves, when used in hydraulic damping system such as those described above, can cause undesirable flow resistance dynamics. For example, the flow resistance in some systems can change in accordance quadratic relationships. This can cause the damping force to change too abruptly or according to the so-called “leak characteristic”. This effect is reflected in FIG. 5.

In FIG. 5, in the area to the right hand side of the arcuate arrows, the damping force changes too quickly in response to changes in stroke speed difference (i.e., the difference in speed between the two hydraulic cylinders). For example, when the spool valve is open and the stroke speed difference is small but increasing (i.e., moving from the left to the right along the stroke speed difference axis) the damping force is at first small, then increases suddenly as the stroke speed difference increases. The characteristic is represented as an S-curve (see FIG. 5) in which the damping force increases suddenly. This compromises ride comfort and maneuvering stability.

Also, where the throttle valve is formed of a spool valve, influence of the viscosity of the working oil on the passage resistance is likely to increase greatly, so that the rate of change in the damping characteristic due to working oil temperature increases.

The variable throttle aperture area can be changed by moving the spool to a position where the solenoid thrust is in balance with the reaction force of the balancing spring. Because of manufacture-related variations in the characteristics of the solenoid and the balancing spring, such as spool clearance, even precise and consistent assembly of the variable throttle does not result in the same aperture area even if the same amount of electric current is supplied. Thus, the preload amount for the balancing spring must be adjusted while measuring the characteristics one by one after assembling the variable throttle. Moreover, the power source for supplying electric current to the solenoid must employ complicated circuitry to provide accurate control of the power source.

In accordance with at least one of the embodiments disclosed herein, a hydraulic damping system for a vehicle can be provided. The damping system can comprise first and second oil chambers in fluid communication with oil chambers of a pair of damping hydraulic cylinders provided on a vehicle body. The first and second oil chambers can be configured such that changes in volume of the first and second oil chambers remain at a constant ratio. The first and second oil chambers can be in fluid communication with each other through a variable throttle. The variable throttle can comprise a plurality of fixed throttles that are fluidically parallel to each other and connecting the first oil chamber and the second oil chamber. An opening-closing valve can be configured to open and close a working oil passage of at least one of the plurality of fixed throttles. Each of the plurality of fixed throttles being can be formed by a plural number of check valves each having a plate spring as a valve member. The plural number of check valves can be disposed in parallel with each other such that working oil flows through them in opposite directions to each other.

In accordance with another embodiment, a hydraulic variable dampening system for a vehicle is provided. The system can comprise a first hydraulic cylinder having a first oil chamber, a second hydraulic cylinder having a second oil chamber, and a intermediate unit comprising a third oil chamber fluidically connected to the first oil chamber and a fourth oil chamber fluidically connected to the second oil chamber. The third and fourth oil chambers can be biased toward a configuration such that a volume of the first oil chamber is the same as a volume of the second oil chamber. The intermediate unit can further comprise at least first and second fixed throttle devices fluidically connecting the third and fourth oil chambers. Additionally, an actuator can be configured to activate and deactivate at least one of the first and second fixed throttle devices.

In accordance with yet another embodiment, a hydraulic variable dampening system for a vehicle is provided. The system can comprise a first hydraulic cylinder having a first oil chamber, a second hydraulic cylinder having a second oil chamber, and a intermediate unit comprising a third oil chamber fluidically connected to the first oil chamber and a fourth oil chamber fluidically connected to the second oil chamber, the third and fourth oil chambers being biased toward a configuration such that a volume of the first oil chamber is the same as a volume of the second oil chamber. The intermediate unit can further comprise at least first and second fixed throttle devices fluidically connecting the third and fourth oil chambers. Additionally, means can be provided for activating and deactivating at least one of the first and second fixed throttle devices.

### BRIEF DESCRIPTION OF THE DRAWINGS

These and other features, aspects and advantages of the present inventions are better understood with reference to preferred embodiments, which are illustrated in the accompanying drawings. The illustrated embodiments are merely exemplary and are not intended to define the outer limits of the scope of the present inventions. The drawings of the illustrated arrangements comprise the following figures:

FIG. 1 is a schematic sectional view of a hydraulic damping system in accordance with an embodiment, with an intermediate portion thereof illustrated in phantom line.

FIG. 2 is an enlarged sectional view of the intermediate portion of FIG. 1.

FIG. 3 is a graph illustrating characteristics of the hydraulic damping system of FIGS. 1 and 2.

FIG. 4 is another graph illustrating characteristics of the hydraulic damping system of FIGS. 1 and 2.

FIG. 5 is a graph illustrating characteristics of a conventional hydraulic damping system.

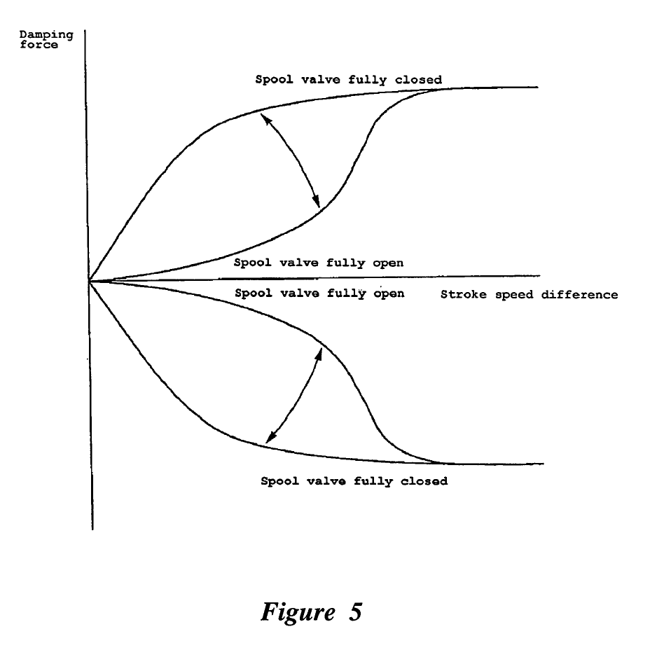

### DETAILED DESCRIPTION OF THE PREFERRED EMBODIMENT

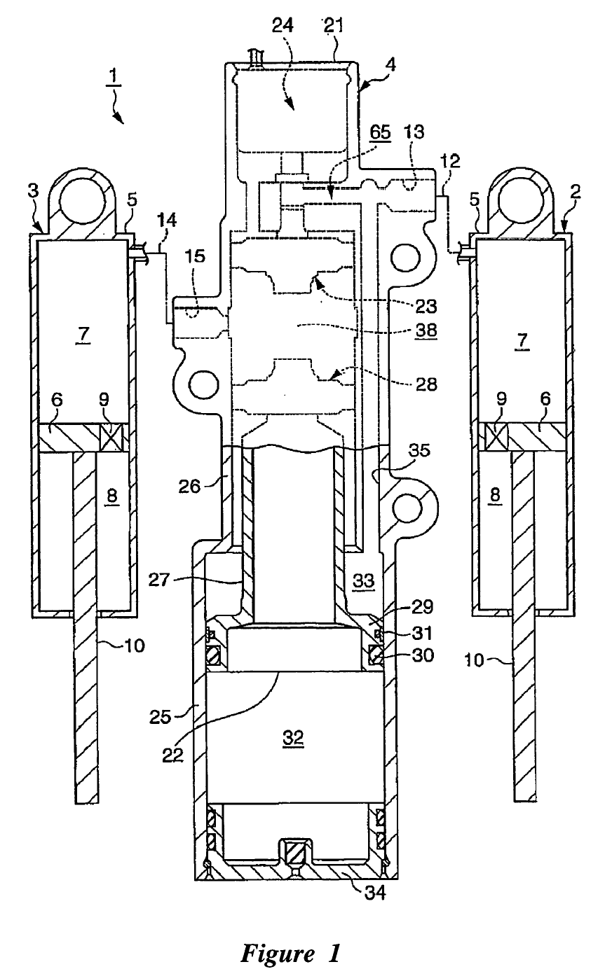

FIG. 1 shows an embodiment of a hydraulic damping system 1 that can be used with an automobile. The damping system 1 is disclosed in the context of an automobile because it has particular utility in this context. However, hydraulic damping system 1 can be used in other contexts, such as, for example, but without limitation, any type of vehicle, including but without limitation, all-terrain vehicles, motorcycles, scooters, golf carts, trucks, or any device or mechanism that can benefit from variable damping control.

The hydraulic damping system 1 can include a pair of damping hydraulic cylinders 2 and 3 provided on a vehicle body (not shown), and an intermediate unit 4 connected to these hydraulic cylinders 2 and 3. As for the two hydraulic cylinders 2 and 3, the interior of their cylinder body 5 can be divided with a piston 6 into an upper oil chamber 7 and a lower oil chamber 8 and can be filled with working oil. The piston 6 can be provided with a throttle 9 for allowing fluid communication between the upper oil chamber 7 and the lower oil chamber 8. However, other configurations can also be used.

The hydraulic cylinders 2 and 3 of this embodiment are interposed between the vehicle body side and a front wheel side. The cylinder body 5 can be attached to the vehicle body of the associated motor vehicle with the lower end of a piston rod 10 pivoted on a part which moves up and down relative to the vehicle body, such as a link front a wheel suspension assembly, such as a front wheel or any other wheel.

The upper oil chamber 7 of the hydraulic cylinder 2 on the right side of the vehicle body (also on the right side in FIG. 1), can be connected through a hydraulic pipe 12 to a first piping connection port 13 of the intermediate unit 4 (described in greater detail below), and the other upper oil chamber 7 of the hydraulic cylinder 3 can be connected through a hydraulic pipe 14 to a second piping connection port 15 of the intermediate unit 4.

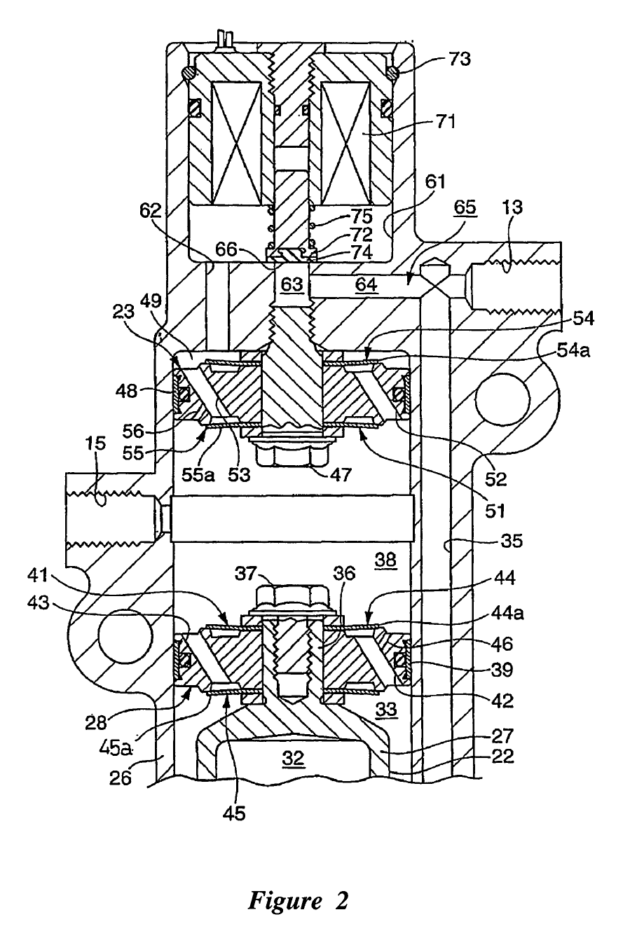

With regard to the intermediate unit 4, as shown in FIGS. 1 and 2, a free piston 22 (described in greater detail below), a partition wall 23, and an opening-closing valve 24 can be provided within a housing 21. The housing 21 can be formed with a first pressure regulating cylinder 25 relatively great in diameter on the lower end in FIG. 1, and a second pressure regulating cylinder 26 relatively small in diameter above the first pressure regulating cylinder 25. However, other configurations can also be used.

The free piston 22 can be made up of a first piston 27 formed to exhibit a generally bottomed cylindrical shape and a second piston 28 attached to the bottom (upper end in FIGS. 1 and 2) of and located on the same axis as the first piston 27. The open side end of the first piston 27 can be formed with an integral piston body 29 which can be relatively great in diameter. The piston body 29 can be provided with an O-ring 30 and a seal ring 31 on its outside round surface, and fit to be freely movable in the first pressure regulating cylinder 25.

The interior of the first pressure regulating cylinder 25 can be divided with the first piston 27 into a high pressure gas chamber 32 and a first oil chamber 33. The high pressure gas chamber 32 can be isolated from the exterior of the cylinder with a lid member 34 fit to the opening on one end of the first pressure regulating cylinder 25 and filled with a high pressure N₂ gas. However, other configurations and gasses can also be used.

The first oil chamber 33 can be filled with working oil and can be in communication with the first piping connection port 13 through a first working oil passage 35 bored in one side portion of the housing 21 to extend parallel to the axis of the first pressure regulating cylinder 25.

With this arrangement, the intermediate unit 4 is biased toward a configuration in which changes in the volume of chamber 7 of cylinder 3 are the same as changes in volume of chamber 7 of cylinder 2. For example, when the rod 10 of cylinder 2 is moved upwardly (as viewed in FIG. 1, the volume of chamber 7 is reduced, thereby urging oil into and thereby increasing the volume of chamber 33. This oil movement urges the first piston 22, and thus the second piston 28, downwardly. Then the piston 28 moves downwardly, the volume of chamber 38 increases, thereby drawing oil from chamber 7 of cylinder 3 into the chamber 38.

The second piston 28 of the free piston 22, as shown in FIG. 2, can be secured using a fixing bolt 37 to a post 36 provided to project from the bottom of the first piston 27. The second piston can be configured for generally free motion in the second pressure regulating cylinder 26 and to divide the interior of the second pressure regulating cylinder 26 into the first oil chamber 33 located in the lower part of the same drawing and a second oil chamber 38. The second piston 28 can be formed in a disk shape, and provided with a seal ring 39 on its outside round surface. The second piston 28 can be also provided with a throttle 41 for allowing fluid communication between the first oil chamber 33 and the second oil chamber 38.

The throttle 41 can be referred to as a fixed throttle. The throttle 41 can include a first communication passage 42 and a second communication passage 43 bored through the second piston 28. Additionally, in some embodiments, the throttle 41 can include check valves 44 and 45 communicating with the passages 42 and 43. However, other configurations can also be used.

The check valves 44 and 45 can include valve members 44a and 45a. In some embodiments, the check valves 44, 45 can comprise plate springs formed in a disk shape. However, other configurations can also be used.

The open ends of the first communication passage 42 and the second communication passage 43 can be opened and closed with the valve members 44a and 45a. The axial center parts of the valve members 44a and 45a can be fit on the post 36 of the first piston 27, and secured to the first piston 27 together with the second piston 28 using the fixing bolt 37. However, other fasteners or fastening techniques can also be used.

The check valve 44 provided in the first communication passage 42 can be configured to permit flow of working oil only from the first oil chamber 33 to the second oil chamber 38. The check valve 45 provided in the second communication passage 43 can be configured to permit flow of working oil only from the second oil chamber 38 to the first oil chamber 33.

In the middle of the first communication passage 42 an orifice 46 can be provided. The orifice 46 cab have of a relatively small diameter for allowing fluid communication between the communication passage 42 and the second oil chamber 38. However, other configurations can also be used.

The second oil chamber 38 can be formed between the second piston 28 and the partition wall 23 located above the second piston 28 in FIG. 2, and filled with working oil. The second oil chamber 38 can be also in fluid communication with the second piping connection port 15 bored in one side portion of the housing 21.

As shown in FIG. 2, the partition wall 23 defining the second oil chamber 38 in cooperation with the second piston 28 can be formed in a disk shape, fit inside the second pressure regulating cylinder 26, and secured to the housing 21 by means of a fixing bolt 47. However, other fasteners and other fastening techniques can also be used. The outside round surface of the partition wall 23 can be also provided with a seal ring 48 to seal the space between the partition wall 23 and the inside circumference of the second pressure regulating cylinder 26.

Further, the partition wall 23 can be provided in the housing 21 to divide the interior of the second pressure regulating cylinder 26 into the second oil chamber 38 and a third oil chamber 49, and can be provided with a throttle 51 to allow fluid communication between the second oil chamber 38 and the third oil chamber 49.

The throttle 51 can be referred to as a fixed throttle, which can be the same in constitution as the throttle 41 provided in the second piston 28. In some embodiments, the throttle 51 can include a first communication passage 52 and a second communication passage 53 bored through the partition wall 23, as well as check valves 54 and 55 disposed in communication with the passages 52 and 53. The check valves 54 and 55 can include valve members 54a and 55a. In some embodiments, the valve members 54a, 55a can comprise plate springs in a disk shape configured to open and close the open ends of the first communication passage 52 and the second communication passage 53. The axial center parts of the valve members 54a and 55a can be fit on the fixing bolt 47 and secured to the housing 21 together with the partition wall 23. However, other fasteners and other fastening techniques can also be used.

The check valve 54 provided in the first communication passage 52 can be configured to permit flow of working oil only from the second oil chamber 38 to the third oil chamber 49. The check valve 55 provided in the second communication passage 53 can be configured to permit flow of working oil only from the third oil chamber 49 to the second oil chamber 38.

In the middle of the second communication passage 53 can be formed an orifice 56 of a relatively small diameter to allow fluid communication between the interior of the communication passage 53 and the second oil chamber 38. The throttle 51 and the throttle 41 can be referred to as a plural number of fixed throttles in some embodiments.

The third oil chamber 49 can be in fluid communication with the interior of a valve hole 61 formed on one side (upper side in FIG. 2) of the housing 21 through a second working oil passage 62. The valve hole 61 can be in fluid communication with the first working oil passage 35 through a third working oil passage 63 and a fourth working oil passage 64 formed in the housing 21 between the valve hole 61 and the second pressure regulating cylinder 26.

The third oil chamber 49, the valve hole 61, and the second through fourth working oil passages 62 through 64 can also be filled with working oil. A bypass passage 65 can comprise these second through fourth working oil passages 62 through 64, the interior of the valve hole 61, and the first and second communication passages 52 and 53 of the partition wall 23. In other words, the throttle 51 of the partition wall 23 can be provided in the way of the bypass passage 65. However, other arrangements can also be used to define a bypass passage.

The third working oil passage 63 can be formed to be located coaxially with the second pressure regulating cylinder 26, with one end opening to the interior of the valve hole 61 to be opened and closed with the opening-closing valve 24 provided within the valve hole 61. The opening is generally identified with reference numeral 66 in FIG. 2.

The opening-closing valve 24 can comprise a valve body 72 movable back and forth relative to the opening 66 with a solenoid 71 serving as a power source to open and close the opening 66, fit within the valve hole 61 and secured with a snap ring 73 so as not to come off. However, other types of actuators and other directions of movement can also be used. In some embodiments, the valve member 72, with a rubber plate 74 fixed to its fore-end facing the opening 66, can be urged with a compression coil spring 75 in the closing direction.

The opening-closing valve 24 is configured to open as the solenoid 71 is energized and thus excited and thereby pulls the valve member 72 up (as viewed in FIG. 2) against the resilient force of the compression coil spring 75. The opening-closing valve 24 can also be configured to close as the solenoid is de-energized, thereby allowing the valve member 72 to move downwardly (as viewed in FIG. 2) along with the resilient force of the compression coil spring 75. The solenoid 71 can be switched between energized and de-energized states with a switch (not shown) operated by an operator, or automatically according to operating conditions of the associated vehicle, for example.

The plural number of fixed throttles 41 and 51, and the opening-closing valve 24 for opening and closing the working oil passage of the fixed throttle 51 can be referred to as a variable throttle in some embodiments.

In the hydraulic damping system 1 including the intermediate unit 4 described above, and where the left and right hydraulic cylinders 2 and 3 move by the same motion amount in the same direction, since the oil pressure in the first oil chamber 33 of the first pressure regulating cylinder 25 and the oil pressure in the second oil chamber 38 of the second pressure regulating cylinder 26 are maintained generally the same, the check valves 44, 45, 54, and 55 provided in the free piston 22 and the partition wall 23 remain in closed state. As a result, in this case, the free piston 22 moves in vertical directions (as viewed in FIGS. 1 and 2), and the all of the damping force can be produced with the throttles 9 of both the hydraulic cylinders 2 and 3.

In the scenario where the left and right hydraulic cylinders 2 and 3 move in opposite directions relative to each other, a difference can be produced between the oil pressure in the first oil chamber 33 and the oil pressure in the second oil chamber 38. First, the motions for a scenario in which the opening-closing valve 24 is closed, is described below.

With the opening-closing valve 24 closed, since working oil cannot flow into or out of the third oil chamber 49, the throttle 51 provided in the partition wall 23 does not function. If a difference is produced between the oil pressure in the first oil chamber 33 and the oil pressure in the second oil chamber 38 as the left and right hydraulic cylinders 2 and 3 move in opposite directions with the opening-closing valve 24 closed, working oil flows through the throttle 41 of the second piston 28 so as to offset the pressure difference between the two oil chambers.

For example, where the hydraulic cylinder 2 on the right side of an associated vehicle body is compressed and the hydraulic cylinder 3 on the left side of the vehicle body is expanded, the oil pressure in the first oil chamber 33 becomes higher than the oil pressure in the second oil chamber 38. At this time, oil pressure works on the check valve 44 of the first communication passage 42, out of the two communication passages 42 and 43 formed in the second piston 28, to push and open the check valve 44. When the oil pressure is greater than the resilient force of the check valve 44, the check valve 44 opens and working oil flows through the first communication passage 42 from the first oil chamber 33 into the second oil chamber 38. In other words, working oil flows through the throttle 41 of the second piston 28.

As working oil flows through the throttle 41 of the second piston 28 as described above, damping force is produced in the intermediate unit 4 in addition to both the throttles 9 and 9 of the hydraulic cylinders 2 and 3. In case the banking direction of the vehicle body is opposite the above description, damping force is produced as the check valve 45 provided in the way of the second communication passage 43 opens and working oil flows through the second communication passage 43 from the second oil chamber 38 into the first oil chamber 33.

When the opening-closing valve 24 is open, the first oil chamber 33 and the third oil chamber 49 are in fluid communication with each other through the first through fourth working oil passages 35, 62-64, and through the interior of the valve hole 61. In this state, oil pressure applied to the first piping connection port 13 is generally equally transmitted to both the first oil chamber 33 and the third oil chamber 49. As a result, when the left and right hydraulic cylinders 2 and 3 move in opposite directions to each other, working oil flows through the throttle 41 of the second piston 28 and the throttle 51 of the partition wall 23 so that the pressure difference is offset between the first and third oil chambers 33 and 49, and the second oil chamber 38.

For example, in case the oil pressure in the first and third oil chambers 33 and 49 becomes higher than the oil pressure in the second oil chamber 38, the check valve 44 of the first communication passage 42 of the second piston 28 opens and working oil flows from the first oil chamber 33 into the second oil chamber 38, while the check valve 55 of the second communication passage 53 of the partition wall 23 opens and working oil flows from the third oil chamber 49 into the second oil chamber 38. In other words, with the opening-closing valve 24 being open, since working oil flows respectively through the two throttles 41 and 51, damping force becomes relatively small in comparison with the case in which the opening-closing valve 24 is closed. Incidentally, resistance produced when working oil flows is set to be greater through the throttle 5 1 than through the throttle 41.

Therefore, the hydraulic damping system 1 provided with this intermediate unit 4 is capable of increasing and decreasing damping force by switching the opened-closed state of the opening-closing valve 24. Since the variable throttle function can be achieved by increasing and decreasing the number of the fixed throttles 41 and 51 being used, both the opening area of the working oil passage and the passage resistance can be made variable.

Moreover, with the plate spring type fixed throttles 41 and 51, in comparison with throttles constituted with spool valve and port, the passage resistance is less affected with the viscosity of working oil. Further, the throttling area has no moving parts, so that the throttle characteristic does not depend on motions of moving parts. In other words, stabilized valve characteristics can be obtained by dimension control for every component.

Since the so-called on-off type opening-closing valve 24 can be used to open and close the working oil passage, the valve need not be of specially high accuracy. Thus, accurate control can be performed using circuitry configured for simply turning on and off electric current. In particular, since the electric current applied to the solenoid 71 has only to produce in the solenoid 71 a thrust that is greater than the resilient force of the compression coil spring 75 for pressing the valve member (plate 74) against the opening 66 of the working oil passage, there is no need of controlling the current with a high degree of precision. Thus, lower cost solenoids, or other actuators, can be used.

Since the second piston 28 and the partition wall 23 of some embodiments can be the same as each other in both shape and dimension, manufacturing costs can be reduced by the use of common components.

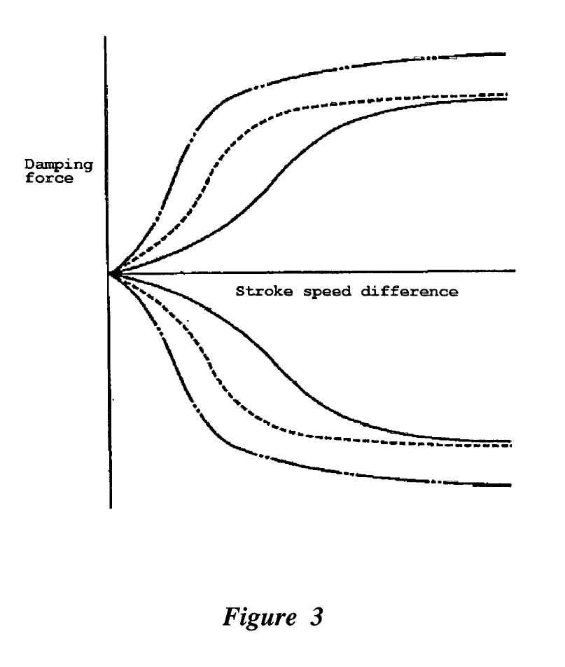

The damping force produced with the intermediate unit 4, as shown in FIG. 3, varies with the stroke speed difference of the left and right hydraulic cylinders 2 and 3 (difference in oil pressure between the first and third oil chambers 33 and 49, and the second oil chamber 38).

FIG. 3 shows an exemplary relationship between the stroke speed difference and the damping force. In the figure, the solid lines represent changes in the damping force in the state where the opening-closing valve 24 is open, the broken lines showing a state where the opening-closing valve 24 is closed, and the dash-and-double-dotted lines illustrating the state when working oil flows only through the throttle 51 of the partition wall 23.

As shown in FIG. 3, with the hydraulic damping system 1 provided with the intermediate unit 4, it can be possible to choose and use one of the two types of damping force characteristics by changing the opening-closing state of the opening-closing valve 24. For example, but without limitation, the opening-closing valve 24 can be closed when high damping forces are desired such as when driving at higher speeds or on winding roads, and opened when a soft ride is desired.

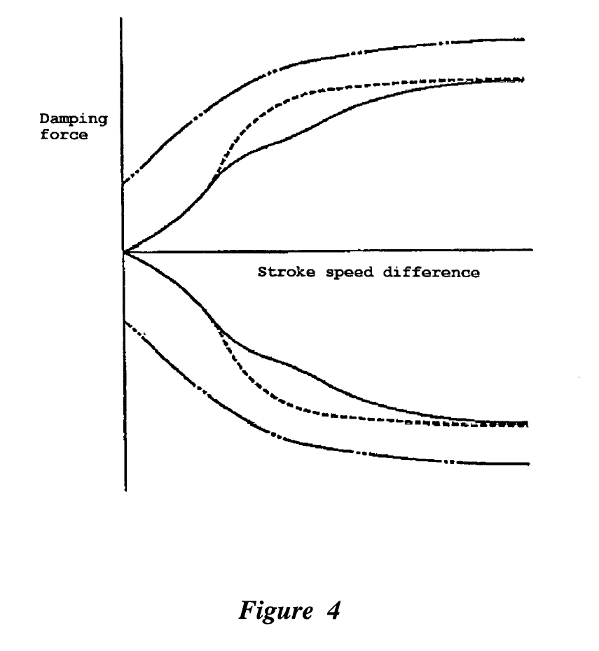

In the intermediate unit 4 of the above embodiment, both the second piston 28 and the partition wall 23 can respectively be provided with the orifices 46 and 55. However, in some embodiments, it can be possible to omit any orifice in the partition wall 23. FIG. 4 illustrates an exemplary relationship between the stroke speed difference and the damping force for such a constitution. In such a case, the damping force can be relatively great when the stroke speed difference is relatively small.

Further, the opening-closing valve 24, besides employing the constitution in which the valve member 72 can be driven with the solenoid 71, may employ a constitution in which the valve can be driven with an electric motor (not shown), or opened and closed manually.

Further, while some of the above embodiments are directed to examples in which the intermediate unit 4 is connected to the left and right hydraulic cylinders 2 and 3 of the front wheel suspension system, in other embodiments, the intermediate unit 4 can be connected to left and right hydraulic cylinders of a rear wheel suspension system, or to a pair of hydraulic cylinders provided in front and rear of the vehicle body. In still other embodiments, the intermediate unit 4 can be connected to a hydraulic cylinder of the front suspension system on one of the left and right sides and to a hydraulic cylinder of the rear suspension system on the other of the left and right sides. Furthermore, it can be possible to arrange the hydraulic cylinders 2 and 3 so that the cylinder body 5 can be pivoted on the wheel side while the piston rod 10 is pivoted on the vehicle body side.

Although these inventions have been disclosed in the context of certain preferred embodiments and examples, it will be understood by those skilled in the art that the present inventions extend beyond the specifically disclosed embodiments to other alternative embodiments and/or uses of the inventions and obvious modifications and equivalents thereof. In addition, while several variations of the inventions have been shown and described in detail, other modifications, which are within the scope of these inventions, will be readily apparent to those of skill in the art based upon this disclosure. It is also contemplated that various combination or sub-combinations of the specific features and aspects of the embodiments may be made and still fall within the scope of the inventions. It should be understood that various features and aspects of the disclosed embodiments can be combined with or substituted for one another in order to form varying modes of the disclosed inventions. Thus, it is intended that the scope of at least some of the present inventions herein disclosed should not be limited by the particular disclosed embodiments described above.

What is claimed is:

1. A hydraulic damping system for a vehicle, the damping system comprising first and second oil chambers in fluid communication with oil chambers of a pair of damping hydraulic cylinders provided on a vehicle body, the first and second oil chambers being configured such that changes in volume of the first and second oil chambers remain at a constant ratio, the first and second oil chambers being in fluid communication with each other through a variable throttle, the variable throttle comprising a plurality of fixed throttles that are fluidically parallel to each other and connecting the first oil chamber and the second oil chamber, and an opening-closing valve configured to open and close a working oil passage of at least one of the plurality of fixed throttles, each of the plurality of fixed throttles being formed by a plural number of check valves each having a plate spring as a valve member, the plural number of check valves being disposed in parallel with each other such that working oil flows through them in opposite directions to each other.

2. The hydraulic damping system for a vehicle of claim 1, wherein the opening-closing valve comprises a valve member configured to reciprocate between a closing position for closing an open end of the working oil passage and an opening position axially spaced from the open end, a spring for pressing the valve member against the open end, and a solenoid for moving the valve member to the opening position against a resilient force of the spring.

3. A hydraulic variable dampening system for a vehicle comprising a first hydraulic cylinder having a first oil chamber, a second hydraulic cylinder having a second oil chamber, a intermediate unit comprising a third oil chamber fluidically connected to the first oil chamber and a fourth oil chamber fluidically connected to the second oil chamber, the third and fourth oil chambers being biased toward a configuration such that a volume of the first oil chamber is the same as a volume of the second oil chamber, the intermediate unit further comprising at least first and second fixed throttle devices fluidically connecting the third and fourth oil chambers, and an actuator configured to activate and deactivate at least one of the first and second fixed throttle devices.

4. The hydraulic variable dampening system according to claim 3, wherein the first fixed throttle device is disposed in a moveable wall disposed between the third and fourth chambers.

5. The hydraulic variable dampening system according to claim 4 additionally comprising a fluidic passage connecting the third and fourth oil chambers, the second fixed throttle device being disposed along the fluidic passage.

6. The hydraulic variable dampening system according to claim 5, wherein the actuator is configured to block and unblock the fluidic passage.

7. The hydraulic variable dampening system according to claim 6, wherein each of the first and second fixed throttle valves comprises at least one throttle passage and at least one plate-type spring member configured to form a check valve with the throttle passage.

8. The hydraulic variable dampening system according to claim 6, wherein each of the first and second fixed throttle valves comprises at least two throttle passages and at least two plate-type spring members configured to form check valves with the throttle passage.

9. The hydraulic variable dampening system according to claim 6, wherein each of the first and second fixed throttle valves comprises first and second throttle passages and first and second plate-type spring members, the first throttle passage and the first plate-type spring member being configured to allow oil to flow only in a first direction between the first and second oil chambers and the second throttle passage and the second plate-type spring member being configured to allow oil to flow only in a second direction, fluidically opposite to the first direction, between the first and second oil chambers.

10. The hydraulic variable dampening system according to claim 3, wherein the third and fourth oil chambers being biased toward a configuration such that a volume of the first oil chamber is the same as a volume of the second oil chamber with a pressurized gas.

11. A hydraulic variable dampening system for a vehicle comprising a first hydraulic cylinder having a first oil chamber, a second hydraulic cylinder having a second oil chamber, a intermediate unit comprising a third oil chamber fluidically connected to the first oil chamber and a fourth oil chamber fluidically connected to the second oil chamber, the third and fourth oil chambers being biased toward a configuration such that a volume of the first oil chamber is the same as a volume of the second oil chamber, the intermediate unit further comprising at least first and second fixed throttle devices fluidically connecting the third and fourth oil chambers, and means for activating and deactivating at least one of the first and second fixed throttle devices.

12. The hydraulic variable dampening system according to claim 11, wherein the first fixed throttle device is disposed in a moveable wall disposed between the third and fourth chambers.

13. The hydraulic variable dampening system according to claim 12 additionally comprising a fluidic passage connecting the third and fourth oil chambers, the second fixed throttle device being disposed along the fluidic passage.

14. The hydraulic variable dampening system according to claim 13, wherein the means for activating and deactivating is configured to block and unblock the fluidic passage.

15. The hydraulic variable dampening system according to claim 14, wherein each of the first and second fixed throttle valves comprises at least one throttle passage and at least one plate-type spring member configured to form a check valve with the throttle passage.

16. The hydraulic variable dampening system according to claim 15, wherein each of the first and second fixed throttle valves comprises at least two throttle passages and at least two plate-type spring members configured to form check valves with the throttle passage.

17. The hydraulic variable dampening system according to claim 14, wherein each of the first and second fixed throttle valves comprises first and second throttle passages and first and second plate-type spring members, the first throttle passage and the first plate-type spring member being configured to allow oil to flow only in a first direction between the first and second oil chambers and the second throttle passage and the second plate-type spring member being configured to allow oil to flow only in a second direction, fluidically opposite to the first direction, between the first and second oil chambers.

18. The hydraulic variable dampening system according to claim 11, wherein the third and fourth oil chambers being biased toward a configuration such that a volume of the first oil chamber is the same as a volume of the second oil chamber with a pressurized gas.
